(19) United States
(12) Patent Application Publication
(10) Pub. No.: US 2009/0053462 A1
(43) Pub. Date: Feb. 26, 2009

(54) PERFLUOROALKYL (METH)ACRYLATE POLYMERS AND THEIR USE AS SURFACTANT AND SUBSTRATE TREATING REAGENTS

(76) Inventors: Ji Guo, Rockville, MD (US); Joseph M. DeSimone, Chapel Hill, NC (US); Paul R. Resnick, Cary, NC (US)

Correspondence Address: MYERS BIGEL SIBLEY & SAJOVEC, PO BOX 37428, RALEIGH, NC, 27627, US

(21) Appl. No.: 11/912,027

(22) PCT Filed: Apr. 21, 2006
(86) PCT No.: PCT/US06/15318

§ 371 Date: Jun. 24, 2008

Related U.S. Application Data
(60) Provisional application No. 60/673,932, filed on Apr. 22, 2005.
(60) Provisional application No. 60/718,244, filed on Sep. 16, 2005.
(60) Provisional application No. 60/724,012, filed on Oct. 6, 2005.

(51) Int. Cl. B32B 5/02; C08F 18/02; C08F 18/20; C08L 27/12; C08K 3/20; B32B 27/10; B05D 1/02; B05D 1/18; B05D 3/00

(52) U.S. Cl. 428/96; 526/246; 526/245; 524/544; 524/545; 524/424; 427/427.4; 427/430.1; 427/372.2; 442/59; 428/511

(57) ABSTRACT

The invention provides a polymer, useful as a surfactant and textile reagent, comprising: (a) monomeric units containing a lipophobic group, said monomeric units comprising a compound of Formula: (I); wherein: Z is a spacer; R is H or methyl; R_{f} is a lipophobic group, R² and R³ are each independently H or halo; X is —O— or a covalent bond; and o is 0 or 1 or 2; (b) optionally but preferably, monomeric units containing an attachment group; and (c) optionally but preferably, monomeric units containing a hydrophobic group.

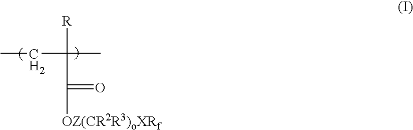

### GOVERNMENT SUPPORT

This invention was made with Government support under a grant from the NSF-STC. The U.S. Government has certain rights to this invention.

### FIELD OF THE INVENTION

The present invention concerns compounds, compositions and methods for treating substrates to impart lipophobic properties, hydrophobic properties, and/or stain resistance thereto.

### BACKGROUND OF THE INVENTION

Certain fluorinated acrylates and methacrylates, previously used in products for imparting stain resistance and/or water repellency to textiles, have been found to produce perfluorooctanoic acid (C-8) or perfluorooctanesulfonic acid (PFOS), which can bioaccumulate. Some of these materials have accordingly been either banned or voluntarily withdrawn from the market, and there is a need for alternatives thereto.

### SUMMARY OF THE INVENTION

The invention describes the novel perfluoroalkyl acrylate or methacrylate polymers (including copolymers, terpolymers and tetrapolymers) and their use as surfactant and textile treating reagents. The polymers can be synthesized in carbon dioxide under high pressure. The fluorinated polymers and derivatives can be used for surfactant and textile reagents.

These novel materials and techniques exhibit several advantages over current systems: (1) The new polymers used for textile reagent have been obtained; (2) They address the environmental problem of degradation to perfluorooctanoic acid (C-8) or perfluorooctanesulfonic acid (PFOS) which can bioaccumulate. The novel materials have reduced bioaccumulation in the environment (3) We disclose a convenient way of synthesize the polymers using the carbon dioxide as the medium.

These novel perfluoroalkyl acrylate and methacrylate polymers and their derivatives provide a wide application in textile field as water and oil repellents. Also these can be applied as novel aqueous or carbon dioxide surfactants.

Thus, a first aspect of the present invention is a polymer comprising:

(a) monomeric units containing a lipophobic group, said monomeric units comprising a compound of Formula I:

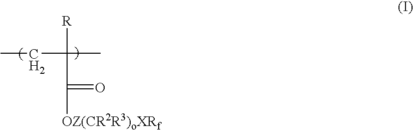

wherein:

Z is a spacer such as —(CH₂)ₙ—, —Y—, —Y(CH₂)ₙ—, —(CH₂)ₙY—, or —(CH₂)ₙY(CH₂)_{n′}—, where Y is aryl (preferably phenyl);

R is H or methyl;

R_{f} is a lipophobic group, preferably C3 to C6 fluoroalkyl optionally containing one or two heteroatoms selected from N and O;

R² and R³ are each independently H or halo;

X is —O— or a covalent bond;

o is 0 or 1 or 2;

n+n′ is 2 or 3 to 6, 8 or 10; and

n+n′+o is not greater than 10;

(b) optionally but preferably, monomeric units containing an attachment group; and

(c) optionally but preferably, monomeric units containing a hydrophobic group.

A second aspect of the present invention is a composition comprising a polymer as described herein in a carrier (e.g., water, carbon dioxide, organic solvents, and combinations thereof).

A third aspect of the present invention is a method of treating a substrate such as a paper product or textile material, comprising; (a) applying a polymer as described herein to said substrate so that said compound is deposited thereon or impregnated therein; and (b) optionally but preferably, drying said substrate.

A further aspect of the present invention is a substrate such as a paper product or textile material comprising carrying, or having contacted thereto, a polymer as described herein (e.g., having a polymer as described herein deposited thereon or impregnated therein).

The foregoing and other objects and aspects of the present invention are explained in greater detail in the specification set forth below. The disclosures of all United States patent references cited herein are incorporated by reference herein in their entirety.

### DETAILED DESCRIPTION OF THE PREFERRED EMBODIMENTS

In general, the invention described herein relates to novel perfluoroalkyl acrylate or methacrylate polymers and their use as surfactant and textile treating reagents. It has been reported that the short chain perfluorinated carboxylic and sulfonic acids do not bioaccumulate or show reduced bioaccumulation. This work relates to the new fluorinated materials compositions based on a fluoropolymer comprising repeating units with four fluorocarbon side chains according to, for examples, general formula CH₂═C(CH₃)COO(CH₂)ₓC₄F₉, where x is from 2 to 4. One or more comonomers (e.g., containing hydrophobic groups or attachment groups) can be introduced to form the copolymer or terpolymer. All the polymers are synthesized in carbon dioxide under high pressure. The fluorinated polymers and derivatives are useful for surfactant and textile reagents.

“Halo” as used herein includes fluoro, chloro, bromo, and iodo.

“Aryl” as used herein, refers to a monocyclic carbocyclic ring system or a bicyclic carbocyclic fused ring system having one or more aromatic rings. Representative examples of aryl include, azulenyl, indanyl, indenyl, naphthyl, phenyl, tetrahydronaphthyl, and the like. Aryl groups may be unsubstituted or substituted 1, 2, 3, or 4 or more times with substituents such as halo (preferably fluoro), methyl, trifluoromethyl, etc.

Fluoroalkyl groups R_{f} of the present invention are preferably C2 to C6 fluoroalkyl, and more preferably C3 to C5 fluoroalkyl. The fluoroalkyl groups may be linear or branched. The fluoroalkyl groups are optionally but preferably perfluoroalkyl (that is, all hydrogens replaced by fluorine); where the fluoroalkyl groups are not perfluorinated then preferably only one or two hydrogens remain, and preferably the remaining hydrogens are not bonded to the terminal or end-chain carbon position (that is, the terminal carbon is preferably substituted by three fluoro groups in the fluoroalkyl groups used herein). The fluoroalkyl groups may contain one or two heteroatoms selected from N and O, examples of which include but are not limited to: —R_{f}¹—O—R_{f}²; —R_{f}¹—NR_{f}²R_{f}³; R_{f}¹—O—R_{f}²—R_{f}³—NR_{f}⁴R_{f}⁵, where R_{f}¹, R_{f}², R_{f}³, R_{f}⁴, and R_{f}⁵ are each independently fluoroalkyl or perfluoroalkyl (subject to the proviso that the total number of carbons in the fluoroalkyl group is as given above).

### 1. Polymers.

As noted above, the present invention provides a polymer comprising, consisting of, or consisting essentially of:

(a) from 20 or 30 to 70 or 80 percent by weight of monomeric units (produced by polymerization of a corresponding monomer) containing a lipophobic group, said monomeric units comprising, consisting of or consisting essentially of a compound of a compound of Formula I:

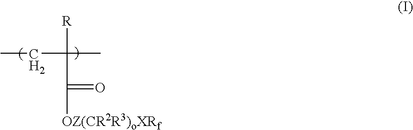

wherein:

Z is a spacer such as —(CH₂)ₙ—, —Y—, —Y(CH₂)ₙ—, —(CH₂)ₙ Y—, or —(CH₂)ₙY(CH₂)_{n′}—, where Y is aryl (preferably phenyl);

R is H or methyl;

R_{f} is a lipophobic group, preferably C3 to C6 fluoroalkyl optionally containing one or two heteroatoms selected from N and O;

R² and R³ are each independently H or halo;

X is —O— or a covalent bond;

o is 0 or 1 or 2;

n+n′ is 2 or 3 to 6, 8 or 10; and

n+n′+o is not greater than 10;

(b) optionally but preferably, from 1 or 2 to 5 or 10 percent by weight of monomeric units (produced by polymerization of a comonomer) containing an attachment group (epoxide, hydroxy, silane or amine group); and

(c) optionally but preferably, from 10 or 20 to 70 or 80 percent by weight of monomeric units (produced by polymerization of a comonomer) containing a hydrophobic group (e.g., a C10-C20 alkyl group).

Specific examples of polymers of Formula I include polymers of Formula Ia, Ib and Ic as discussed in greater detail in connection with monomers below.

The polymers may have any suitable molecular weight, for example, from 1,000 or 2,000 daltons up to 5,000 daltons, or in some embodiments up to 50,000 or 100,000 daltons or more.

Any suitable comonomer (generally ethylenically unsaturated compounds) can be used as for the comonomer containing the hydrophobic group or the comonomer containing the attachment group, including but not limited to those described in U.S. Pat. No. 6,660,803. Thus examples of suitable comonomers are compounds included in the following groups (a), (b) and (c). However, the ethylenically unsaturated compound is not limited to these examples, and may be basically an ethylenically unsaturated compound capable of copolymerizing with a (meth)acrylic acid.

Examples of the group (a) include ethylene, vinyl acetate, vinyl chloride, vinylidene halide, (meth)acrylic acid, (meth)acrylonitrile, styrene, alphamethylstyrene, p-methylstyrene, (meth)acrylamide, N-methylol (meth)acrylamide, hydroxymethyl (meth)acrylate, hydroxyethyl (meth)acrylate, hydroxypropyl (meth)acrylate, 3-chloro-2-hydroxypropyl (meth)acrylate, polyethylene glycol (meth)acrylate, polypropylene glycol (meth)acrylate, methoxypolyethylene glycol (meth)acrylate, methoxypolypropylene glycol (meth)acrylate, N,N-dimethylaminoethyl (meth)acrylate, N,N-diethylaminoethyl (meth)acrylate, glycidyl (meth)acrylate, tetrahydrofurfuryl (meth)acrylate, benzyl (meth)acrylate, phenoxyethyl (meth)acrylate, dicyclopentenyl (meth)acrylate, hydroxypropyltrimethylammonium chloride methacrylate, ethyltrimethylammonium chloride methacrylate, vinyl alkyl ether, alkyl vinyl ether halide, butadiene, isoprene, chloroprene, and maleic anhydride.

Examples of the group (b) include (meth)acrylates represented by the general formula (Formula 4):

CH₂═CA¹COOA² (Formula 4)

[wherein A¹ represents a hydrogen atom or a methyl group, and A² represents an alkyl group represented by CₘH₂ₘ+1 (m represents an integer of 1 to 30)].

Examples of the group (c) include compound represented by the formula 5:

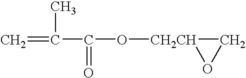

manufactured by KYOEISHA CHEMICAL Co., LTD. under the trade name of LIGHT-ESTER G), compound represented by the formula 6:

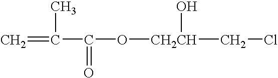

(manufactured by KYOEISHA CHEMICAL Co., LTD. under the trade name of LIGHT-ESTER CL), compound represented by the formula 7:

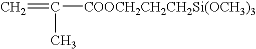

(manufactured by DOW CORNING TORAY SILICONE CO., LTD. under the trade name of SZ6030), the compound represented by the formula 8:

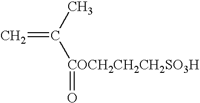

the compound represented by the formula 9:

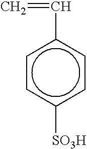

and compounds (sulfonic acid-containing monomers) represented by the formula 10:

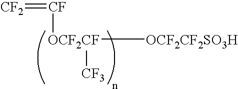

where n=1 to 20.

### 2. Monomers.

A. Polymers of Formula Ia: In some embodiments of the invention, the polymer of Formula I is a polymer of Formula Ia:

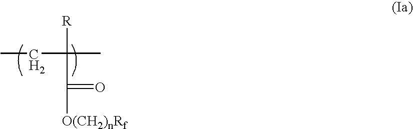

wherein: R and R_{f} are as given above, and n is 2 to 10.

Polymers of Formula I and Ia can be provided by polymerizing the necessary monomers and/or comonomers. In general, a method of making a polymer of Formula I, comprises polymerizing a monomer of Formula II:

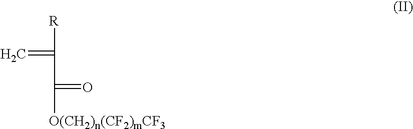

optionally in the presence of a comonomer (such as described above), to produce the polymer of Formula I or Ia. R, n and m in Formula II are the same as given for Formula I. The polymerizing step may be carried out by conventional techniques such as solution, emulsion, or bulk polymerization, or may be carried out in liquid or supercritical carbon dioxide. The polymerizing step is preferably carried out in the presence of an initiator such as AIBN.

Monomers for the production of compounds of Formula Ia can be made in accordance with known techniques or variations thereof that will be apparent to those skilled in the art. For example, one preparation of such a monomer is based on S_{N2} reactions of the anion generated by the addition of fluoride ion to hexafluoropropene (HFP) dimer.[See, e.g., Dmowski et. al. J. Fl. Chem. 1987 36 385; ibid 1988 41 191; ibid 1990 48 77]:

CF₃CF₂CF₂C(CF₃)₂CH₂CH═CH₂

The use of

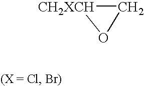

can provide the epoxide directly: which can be converted to a fluorinated heptanol. HFP dimer is prepared virtually quantitatively by the fluoride ion catalyzed dimerization of HFP. The isomer shown is the thermodynamic isomer but Dmowski has shown that a mixture of this isomer with the kinetic isomer, (CF₃)₂CFCF═CFCF₃ works well.

The preparation of alcohols with a CF₃CF₂CF₂C(CF₃)₂— end is attractive because HFP is a commercially produced monomer which can be converted almost quantitatively to the dimer. In addition, the number of unit operations for the synthesis of these alcohols can be reduced. No iodo compounds are required, thus providing the potential to eliminate the expense of recycling iodine. One example of a synthesis of such an alcohol is as follows.

CF₂═CFCF₃→CF₃CF₂CF═C(CF₃)₂+CF₃CF₂CF₂C(CF₃)₂CH₂CH═CH₂→CF₃CF₂CF₂C(CF₃)₂CH₂CH₂CH₂OH

Another synthesis for a monomer useful for making polymers of Formula Ia is as follows:

a) CF₃CF₂CF₂CF₂I+CH₂═CF₂→CF₃CF₂CF₂CF₂CH₂CF₂I [1]

b) [1]+CH₂═CHCH₂OH→CF₃CF₂CF₂CF₂CH₂CF₂CH₂CHICH₂OH [2]

c) [2]-------->CF₃CF₂CF₂CF₂CH₂CF₂CH₂CH₂CH₂OH [3] reduce

d) [3]-------->CH₂═C(CH₃)COOCH₂CH₂CH₂CF₂CH₂CF₂CF₂CF₂CF₃ [4]

CF₃CF₂CF₂CF₂CH₂CF₂I [CAS 24394-24-9] is known and described in U.S. Pat. No. 6,610,790 (See also J. Fl. Chem. 1995 70 215, J. Fl. Chem. 2000 102 253, U.S. Pat. No. 4,587,366, U.S. Pat. No. 3,979,469 and CA 71:2955). In most references method (a) is used.

CF₃CF₂CF₂CF₂CH₂CF₂CH₂CHICH₂OH [CAS 53693-78-0] is known and described in U.S. Pat. No. 3,979,469. Compounds [3] and [4] are novel. Note that a series of monomers CH₂═C(CH₃)COO(CH₂)ₙCF₂CH₂CF₂CF₂CF₂CF₃, may be prepared where n>3 by using CH₂═CH(CH₂)ₘOH where m>1 in place of CH₂═CHCH₂OH.

In addition, a similar series of monomers is prepared in the same way using other iodides with five carbon atoms or less. Examples include n-C₅F1Ii, iC₃F₇I, CF₃CFICF₂CF₃, (CF₃)₂CFCF₂I and a mixture of CF₃CFICF₂CF₂CF₃ and CF₃CF₂CFICF₂CF₃.

B. Polymers of Formula Ib: In some embodiments of the invention, the polymer of Formula I is a polymer of Formula Ib:

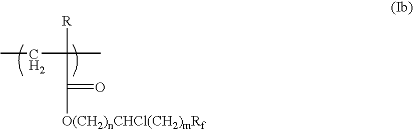

wherein: R and R_{f} are as given above, n is 1 to 9; and m is 2 to 4.

Monomers for the production of compounds of Formula Ib can be made in accordance with known techniques or variations thereof that will be apparent to those skilled in the art. For example, a route to add a C₄F₉ group to a hydrocarbon chain is via free radical addition of C₄F₉SO₂Cl to olefins. This is analogous to the addition of CCl₃SO₂Cl to olefins that results in the addition of the elements of CCl₄ across the double bond. C₄F₉SO₂F is known (See, e.g., 3M product announcement for this compound as PBSF Activating Agent L-15676). The sulfonyl fluoride can be converted to C₄F₉SO₂Cl by reduction followed by chlorination as described in U.S. Pat. Nos. 2,950,317 and 3,420,877. Examples of the addition to olefins are found in U.S. Pat. No. 2,950,317.

C₈F₁₇SO₂Cl+CH₂═CH(CH₂)_{g}COOH→C₈F₁₇CH₂CHCl(CH₂)₈COOH 79%

C₈F₁₇SO₂Cl+CH₂═CHSi(Cl₂)CH₃→C₈F₁₇CH₂CHClSi(Cl₂)CH₃

Thus, the process to produce an alcohol is simpler and does not require the use of expensive iodine. The chlorine in the addition product should remain in the final monomer and polymer since it is much less reactive than the corresponding iodide and should not interfere with the final properties of the textile treating agent. One example of using this general synthesis is as follows.

C₄F₉SO₂Cl+CH₂═CHCH₂CH₂OH→C₄F₉CH₂CHClCH₂CH₂OH

C. Polymers of Formula Ic: In some embodiments of the invention, the polymer of Formula I is a polymer of Formula Ic:

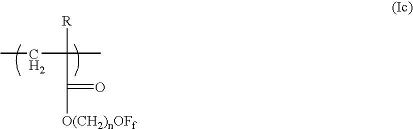

wherein R and R_{f} are as given above, and n is 5 to 10.

Monomers for the production of polymers of Formula Ic can be made in accordance with known techniques or variations thereof that will be apparent to those skilled in the art. For example, a fluorinated alcohol based on the reaction of fluorinated ketones and to a lesser extent fluorinated acyl fluorides with fluoride ion to give alkoxides followed by reaction with alkyl halides to give partially fluorinated ethers can be used to provide monomers useful for the production of polymers of Formula Ic. One example of such an reaction is the preparation of an allyl ether from hexafluoroacetone and allyl bromide:

(CF₃)₂C═O+CsF+CH₂═CHCH₂Br→(CF₃)₂CFOCH₂CH═CH₂

(J. Poly. Sci. Part A-1 1966 4 2637). A similar type of reaction has been used for the preparation of the hydrofluoroethers C₄F₉OR(R═CH₃, HFE-7000; C₂H₅, IIFE-7100) and (CF₃)₂CFCF(C₂F₅)OCH₂CH₃ (HFE-7500).

Alcohols useful in the present invention can be prepared from ketones such as CF₃CF₂C(O)R_{f} [R_{f}=CF₃, C₂F₅, iC₃F₇]. CF₃CF₂COCF(CF₃)₂ is prepared in high yield in a single step by the KF catalyzed reaction of hexafluoropropene and perfluoropropionyl fluoride.

CF₃CF₂COF+CF₂═CFCF₃→CF₃CF₂C(O)CF(CF₃)₂→(CF₃)₂CFCF(C₂F₅)OCH₂CH₃

This is followed by reaction of the ketone with KF and diethyl sulfate to give HFE-7500.

Ketones, CF₃CF₂C(O)R_{f}, [R_{f}=CF₃, C₂F₅] are prepared by the reaction of CF₂═CF₂ and either CF₃COF or COF₂ catalyzed by fluoride ion.

When R_{f}=iC₃F₇, the ketone is commercially available. In addition, the number of unit operations for the synthesis of these alcohols can be reduced and the use of iodo compounds can, if desired, be eliminated. One example of such a synthesis is an alcohol is as follows.

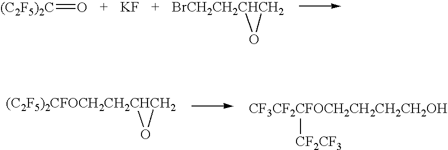

These fluorinated alcohols are converted to the corresponding methacrylate or acrylate esters and polymerized with other monomers to give polymers that are useful in treating fabrics to give hydrophobic and oleophobic properties and do not degrade in the environment to give C-8.

Another way to extend the side chain of a methacrylate or acrylate polymer and still keep a small amount of fluorine (e.g., 4-6 fluorinated carbon atoms) on the end of the side chain is: R_{f}CH₂OH+either ethylene oxide or ethylene carbonate ------>R_{f}CH₂OCH₂CH₂OH (You could put two molecules of ethylene oxide to give R_{f}CH₂OCH₂CH₂OCH₂CH₂OH but this is not a very specific reaction.) Any fluorinated ether R_{f}COOCH₃ undergoes facile reduction to R_{f}CH₂OH with NaHBH₄ so numerous structures for R_{f} can be used.

In addition, CF₃CF₂CF₂OCF(CF₃)— [from HFPO dimer], CF₃CF₂CF₂CF₂— [from perfluoropentanoic acid], sidechains based on HFP dimer, CF₃CF₂CF₂C═C(CF₃)₂, on CF₃CF═CFCF₂CF₃ (from HFP and TFE) and H(CF₂)₄— from the telomerization of TFE with methanol. For example: CF3CF═CFCF2CF3--->epoxide--->CF₃CFHCH(OH)CF₂CF₃+CF₃CH(OH)CFHCF₂CF₃.

H(CF₂)₄CH₂OCH₂CH₂OH [CAS 50997-69-8] is know and is made from H(CF₂)₄CH₂OH and either ethylene oxide or ethylene carbonate (See, e.g., U.S. Pat. Nos. 4,906,792 and 5,157,159. Note also that acrylates and cyanoacrylates of these polymers can be polymerized (See U.S. Pat. Nos. 3,394,115 and 3,532,674). Monomers of this type are useful for the production of polymers of the present invention.

### 3. Compositions, Methods of Use and Products.

For convenient use, the polymers described above can be provided in a carrier to form a composition, with about 0.01 or 0.1 up to 20, 30, or 50 percent by weight of the composition being the polymer. Any suitable carrier can be employed, including carbon dioxide, organic solvents, and combinations thereof. Any suitable organic solvent can be used, including but not limited to alcohols, aromatic solvents, esters, ketones, aliphatic solvents, and combinations thereof (and more particularly acetone, hexane, cyclohexane, methanol, ethanol, ethyl acetate, toluene, acetone, methyl ethyl ketone, and mixtures thereof). The composition can be provided in any suitable form as desired for the particular end use by adjusting the carrier or carriers and how the ingredients are combined in accordance with known techniques, such forms including but not limited to solutions, dispersions, suspensions, emulsions and microemulsions (including water emulsions and dispersions).

In some embodiments where the composition is an emulsion or dispersion, the composition comprises dispersed particles comprising, consisting of or consisting essentially of a polymer of the invention, typically in an average particle size of 5, 10 or 20 to 400, 600 or 800 nm dispersed in an aqueous phase comprising, consisting of or consisting essentially of water, with the emulsion or dispersion having an amount of solids between 20 or 30 and 70 or 80 percent by weight. The compositions can be provided in dilute form, or in concentrated form for subsequent dilution if desired.

In use, a textile material can be treated by (a) applying a polymer as described above to the textile material so that said compound is deposited thereon (e.g., by meniscus coating such as dip coating, withdrawal coating, slot coating, and drainage coating processes, spraying, or any other suitable application technique, and then, optionally but preferably, (b) drying said textile material (e.g., by drying at ambient temperature or heating to an elevated temperature). Any suitable textile material can be treated, including but not limited to cotton, wool, silk, polyesters, polyamides and blends thereof. The textile material can be in any suitable form, including woven and nonwoven fabrics, as well as threads, yarns, etc.

The textile material can be in the form of a garment or article of clothing (e.g., shirts, pants, skirts, ties, outerware such as coats and jackets), or the textile material can be formed into such a garment after treatment.

In addition to textile materials other organic and inorganic substrates, including but not limited to paper products (e.g., sheet paper, paperboard, cardboard, etc.), wood, polymers, metals, inorganic crystalline or semicrystalline materials such as quartz, glass or silicon dioxide, conductors, semiconductors, insulators, and composites thereof (including composites formed with textile materials), etc. can likewise be treated, coated with, or impregnated with compounds and compositions of the invention treated by the method of the invention. Treating can be carried out by any suitable technique including but not limited to those described in connection with textile materials above.

In the manufacture of paper products the treating or applying step can be carried out after the paper product is formed or during production of the paper product (e.g., by including the compounds or compositions into the pulp slurry before web formation, applying the compounds or compositions to a fibrous web before drying, applying the compounds or compositions to the fibrous web after drying, etc.). Paper products can be formed or shaped into useful articles such as cartons, boxes, containers or the like (particularly for food packaging to produce packages configured to contain, or containing, meat, ground meat, pizza, bread or other baked goods, etc.) comprising the paper product, in accordance with known techniques.

Wallpaper (or wallcoverings) and carpet (including either, or both, the front surface or the back surface of carpet) may also be coated by the method of the present invention, for example to apply a stain-resistant coating thereto.

The thickness of the coating formed on the substrate after evaporation of any carrier composition will depend upon the particular coating component employed, the substrate employed, the coating method, the purpose of the process, etc., but can range between about five or ten Angstroms up to one or five millimeters or more.

The present invention as described above can be implemented in accordance with further features or elements, including but not limited to those described in U.S. Pat. Nos. 3,462,296; 3,282,905; and 3,491,169; US Patent Application No. 2004/0048974; and in Shean-Jeng Jong and Hong-Yue She, Taiwan Patent Application 583302 (assigned to Chung-Shan Institute of Science & Technology).

The present invention is explained in greater detail in the following non-limiting examples.

### EXAMPLES 1-4

### Formation of the Polyperfluorobutyl Methacrylate Homopolymer, Copolymer and Terpolymer

### Example 1

General method for the synthesis of 1-perfluoroalkyl-2-iodoalkanes (Scheme 1). Sodium dithionite and sodium bicarbonate are added to a mixture of water and acetonitrile (1:1 v/v). The solution is cooled for 15 minutes in an ice bath. Perfluorobutyl iodide and vinyl alcohol are slowly added to the solution following which the system is allowed to warm to ambient temperature. After 10 hours, the mixture is poured into water and extracted three times with ether. The combined organic layers are washed with saturated brine and dried with magnesium sulfate. The product is isolated in 75% yield by distillation at reduced pressure.

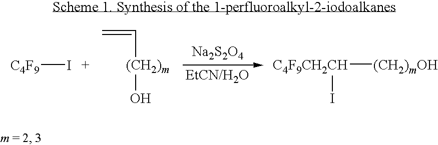

### Example 2

General method for the synthesis of fluorinated alcohol (Scheme 2). A mixture of 1-perfluoro-2-iodoalkane, zinc powder and ether is stirred and heated to reflux. Glacial acetic acid is added dropwise to the mixture when the temperature is approximately 50 degrees. After 10 hours, the liquid is decanted and the residue washed several times with ether. The organic layers are combined, washed four times with saturated sodium bicarbonate and dried with magnesium sulfate. The product is isolated by distillation at reduced pressure.

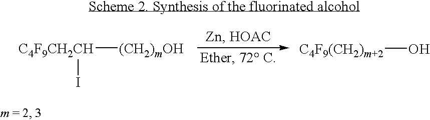

### Example 3

General method for the synthesis of fluorinated alkyl methacrylate (Scheme 3). A fluorinated alcohol, ether and triethylamine mixture is purged with argon for two hours while cooled by an ice bath. Methacryloyl chloride is added dropwise to the mixture. The ice bath is removed and the mixture is allowed to stand at ambient temperature overnight. The mixture is extracted four times with brine and dried with magnesium sulfate. The product is isolated by distillation at reduced pressure.

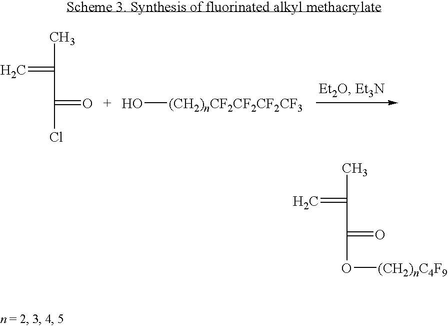

### Example 4

General method for the synthesis of fluorinated alkyl methacrylate homopolymer or copolymer or terpolymer (Scheme 4). The monomer(s) along with 0.5-1.0 wt. percent AIBN as an initiator, are placed into a 10 ml. high pressure cell. The mixture is purged with argon for 30 minutes. The temperature is raised to 60 degrees and the pressure is raised to 4000 psi by pressurizing the reactor with CO₂. The polymerization is allowed to proceed for 36 hours. The polymers are isolated by solution in benzotrifluoride followed by precipitation by the addition of methanol.

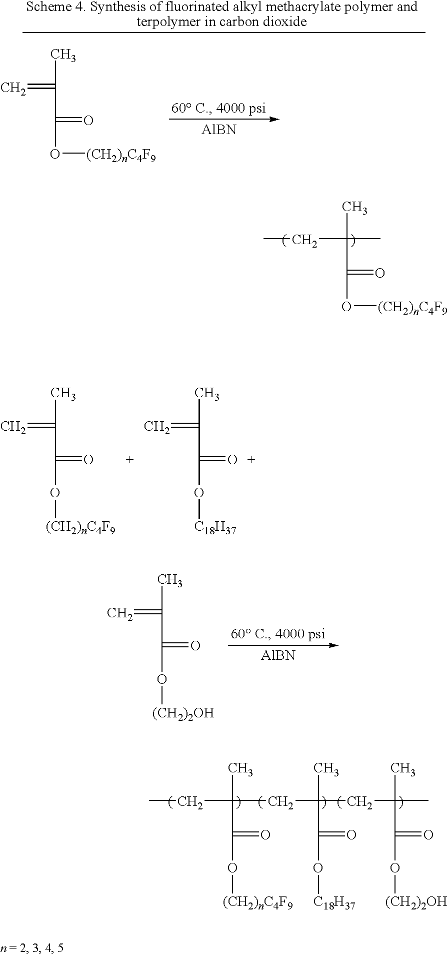

### Example 5

A solution of 23.4 g. CF₃CF₂CF₂CF₂CH₂CF₂CH₂CHICH₂OH (U.S. Pat. No. 6,824,882) and 15 ml. ethanol is added dropwise to a slurry 25 g. of zinc, 150 ml. ethanol and 1.5 g. acetic acid with stirring over a one hour period. The mixture is heated for four hours at 50°, filtered and concentrated. The concentrate is dissolved in chloroform, filtered and the solvent evaporated. Distillation gives approximately 8.5 g. of CF₃CF₂CF₂CF₂CH₂CF₂CH₂CH₂CH₂OH whose structure is confirmed by IR and NMR spectra.

### Example 6

A mixture of the fluorinated alcohol, ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. The product, CF₃CF₂CF₂CF₂CH₂CF₂CH₂CH₂CH₂OOCC(CH₃)═CH₂, is isolated by distillation at reduced pressure.

### Example 7

A mixture of 3.2 g. [CF₃CF₂CF₂OCF(CF₃)C(O)O]₂ (See, J. Org. Chem. 1982 47 2009) 0.7 g. phenol and 10 ml. perfluorodimethylcyclobutane is heated at 40° for six hours. Distillation gives approximately 2.0 g. CF₃CF₂CF₂OCF(CF₃)C₆H₄OH whose structure is confirmed by IR and NMR spectra.

### Example 8

A mixture of the fluorinated alcohol, ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. The product, CF₃CF₂CF₂OCF(CF₃)C₆H₄OOCC(CH₃)═CH₂, is isolated by distillation at reduced pressure.

### Example 9

A mixture of the CF₃CF₂CF₂CF₂CH₂OCH₂CH₂OCH₂CH₂OH (see U.S. Pat. No. 2,723,999), ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. CF₃CF₂CF₂CF₂CH₂OCH₂CH₂OCH₂CH₂OOCC(CH₃)═CH₂, is isolated by distillation at reduced pressure.

### Example 10

A mixture of 14.5 g. CF₃CF₂CF₂CF₂CH₂OH (available from SynQuest Laboratories Inc. Alachua, Fla., USA), 8.0 g. ethylene carbonate and 0.3 g. tetramethylammonium iodide is heated slowly to 140° for 48 hours. The reaction mixture is cooled and poured into a mixture of 25 ml. ether and 25 ml. water. The organic layer is separated, dried with magnesium sulfate, filtered and distilled to give 11 g. CF₃CF₂CF₂CF₂CH₂OCH₂CH₂OH whose structure is confirmed by IR and NMR spectra.

### Example 11

A mixture of CF₃CF₂CF₂CF₂CH₂OCH₂CH₂OH, ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. CF₃CF₂CF₂CF₂CH₂OCH₂CH₂OOCC(CH₃)═CH₂, is isolated by distillation at reduced pressure. See U.S. Pat. Nos. 4,906,792 and 5,157,159.

### Example 12

Sodium hydride, 1.2 g., is added to a solution of 15.8 g. CF₃CF₂CF₂OCF(CF₃)CH₂OH (available from Oakwood Products Inc. West Columbia, S.C., USA) in 30 ml. of ethanol. After stirring at ambient temperature 8.1 g. 4-chloro-butanol is added slowly and the reaction heated to 60° for 3 hours. The reaction mixture is cooled, added to 100 ml ice water and the organic layer separated. The aqueous layer is extracted three times with 25 ml. ether. The ether extracts were combined with the initial organic layer, dried with magnesium sulfate and distilled to give 11.6 g. CF₃CF₂CF₂OCF(CF₃)CH₂OCH₂CH₂CH₂CH₂OH whose structure is confirmed by IR and NMR spectra.

### Example 13

A mixture of CF₃CF₂CF₂OCF(CF₃)CH₂OCH₂CH₂CH₂CH₂OH, ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. CF₃CF₂CF₂OCF(CF₃)CH₂OCH₂CH₂CH₂CH₂OOCC(CH₃)═CH₂, is isolated by distillation at reduced pressure.

### Example 14

A mixture of 19.1 g. CF₃CF₂CF₂CF₂SO₂Cl, 8.6 g. CH₂═CHCH₂CH₂CH₂OH and 0.5 g. benzoyl peroxide is heated at 1000 for 8 hours. The mixture is cooled and distilled to give 12.3 g. CF₃CF₂CF₂CF₂CH₂CHClCH₂CH₂CH₂OH whose structure is confirmed by IR and NMR spectra.

### Example 15

A mixture of CF₃CF₂CF₂CF₂CH₂CHClCH₂CH₂CH₂OH, ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. CF₃CF₂CF₂CF₂CH₂CHClCH₂CH₂CH₂OOCC(CH₃)═CH₂ is isolated by distillation at reduced pressure.

### Example 16

A well dried flask is charged with 22.5 ml. of one molar stabilized BH₃ in tetrahydrofuran (Aldrich Chemical Co. Milwaukee Wis., USA: 1.0M solution of borane-tetrahydrofuran complex stabilized with 0.005 M 1,2,2,6,6-pentamethylpiperidine) and 34 ml. of anhydrous tetrahydrofuran. The contents were cooled to 0° and 16.2 g. CF₃CF₂CF₂C(CF₃)₂CH₂CH═CH₂ (J. Fluorine Chemistry 1987 36 385; ibid. 1988 41 191; ibid. 1990 48 77) added over a five minute period. The reaction mixture is stirred at room temperature for two hours and then cooled to 100 followed by addition of 27 ml of 3M aqueous sodium hydroxide. Then 9 ml. of 30% aqueous hydrogen peroxide is added and the reaction mixture stirred at 500 for two hours. After cooling to room temperature 60 ml. of ether were added, the organic phase separated and ished successively with 60 ml. of water and 60 ml. of brine followed by drying with magnesium sulfate. After filtration the organic phase is distilled to give 13.6 g. CF₃CF₂CF₂C(CF₃)₂CH₂CH₂CH₂OH whose structure is confirmed by IR and NMR spectra.

### Example 17

A mixture of CF₃CF₂CF₂C(CF₃)₂CH₂CH₂CH₂OH, ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. CF₃CF₂CF₂C(CF₃)₂CH₂CH₂CH₂OOCC(CH₃)═CH₂ is isolated by distillation at reduced pressure.

### Example 18

A well dried flask is charged with 5.8 g. anhydrous KF, 75 ml. of 1,2-dimethoxyethane and 31.6 g. (CF₃)₂CFC(O)CF₂CF₃ (3M Corporation, USA). The mixture is stirred at room temperature for one hour, 7.6 g. allyl chloride added and stirred for four hours. The reaction mixture is added to 200 ml ice water and the organic phase separated. The aqueous phase is extracted two times with 25 ml. ether. The combined organic phases were ished with 50 ml water, ished with 50 ml brine, dried with magnesium sulfate and distilled to give 21 g. (CF₃)₂CFCF(CF₂CF₃)OCH₂CH═CH₂ whose structure is confirmed by IR and NMR spectra.

### Example 19

A well dried flask is charged with 22.5 ml. of one molar stabilized BH₃ in tetrahydrofuran (Aldrich Chemical Co. Milwaukee Wis., USA 1.0M solution of borane-tetrahydrofuran complex stabilized with 0.005 M1,2,2,6,6-pentamethylpiperidine) and 34 ml. of anhydrous tetrahydrofuran. The contents were cooled to 0° and 16.9 g. (CF₃)₂CFCF(CF₂CF₃)OCH₂CH═CH₂ added over a five minute period. The reaction mixture is stirred at room temperature for two hours and then cooled to 10° followed by addition of 27 ml of 3M aqueous sodium hydroxide. Then 9 ml. of 30% aqueous hydrogen peroxide is added and the reaction mixture stirred at 500 for two hours. After cooling to room temperature 60 ml. of ether were added, the organic phase separated and ished successively with 60 ml. of water and 60 ml. of brine followed by drying with magnesium sulfate. After filtration the organic phase is distilled to give 12.4 g. (CF₃)₂CFCF(CF₂CF₃)OCH₂CH₂CH₂OH whose structure is confirmed by IR and NMR spectra.

### Example 20

A mixture of (CF₃)₂CFCF(CF₂CF₃)OCH₂CH₂CH₂OH, ether and triethylamine mixture is purged with argon for two hours while cooled in an ice bath. Methacryloyl chloride is added dropwise to the mixture, the ice bath removed and the resulting mixture allowed to stand at ambient temperature overnight. The mixture is extracted four times with brine and dried with magnesium sulfate. (CF₃)₂CFCF(CF₂CF₃)OCH₂CH₂CH₂OOCC(CH₃)═CH₂ is isolated by distillation at reduced pressure.

### Example 21

An additional example of a monomer useful for carrying out the present invention is:

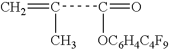

(in Formula I where Z=aryl, o=0, X=covalent bond, R_{f}=C₄F₉)

A synthetic route for the synthesis of such a monomer is as follows:

C₆H₆+(n-C₄F₉COO)₂→nC₄F₉C₆H₅

(There are quite a few references to the addition of perfluoro groups to aromatics by decomposition of perfluoroacyl peroxides)

nC₄F₉C₆H₅+(Ac)₂O→CH₃COC₆H₄C₄F₉

[CAS 152330-65-9] J. Fl. Chem. 1995 71(1) 21.

CH₃COC₆H₄C₄F₉→CH₃COOC₆H₄C₄F₉

### (Baeyer-Villiger) [CAS 88951-00-2]

CH₃COOC₆H₄C₄F₉→CH₂═C(CH₃)COOC₆H₄C₄F₉

via ester exchange or through the phenol

4-HOC₆H₄C₄F₉ [CAS 123068-23-5]

(see Zh. Org. Khim 1983 19(10)2055 CA 100:102871)

### Example 22

An additional example of a monomer useful for carrying out the present invention is:

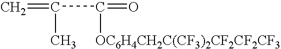

(in Formula I where Z=aryl, R²═R³═H, o=1, R_{f}=—C(CF₃)₂CF₂CF₂CF₃, X=covalent bond)
One synthetic route for the synthesis of such a monomer is as follows:

C₆H₅CH₂Br+(CF₃)₂C═CFCF₂CF₃ [HFP dimer]→C₆H₅CH₂C(CF₃)₂CF₂CF₂CF₃

CAS 64356-97-4 (This reaction has been reported in the literature)

→CH₃COC₆H₄CH₂C(CF₃)₂CF₂CF₂CF₃

→CH₃COOC₆H₄CH₂C(CF₃)₂CF₂CF₂CF₃

### (CAS 104554-41-8 not in CA JP 04 049534 CA 105:152715)

→HOC₆H₄CH₂C(CF₃)₂CF₂CF₂CF₃

### (CAS 139055-04-2; JP 03 246243 CA 116:128362)

A route used was:

p-C₆H₅COOC₆H₄CH₂Br→p-C₆H₅COOC₆H₄CH₂C(CF₃)₂CF₂CF₂CF₃→pdt.

(p-CH₂═CXCOOC₆H₄CH₂C(CF₃)₂CF₂CF₂CF₃ X═H, CH₃ are not in CA)

### Example 23

An additional example of a monomer useful for carrying out the present invention is:

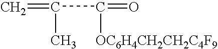

(in Formula I where Z=aryl, R²═R³=H, o=2, X=covalent Bond, R_{f}=C₄F₉)

This monomer may be synthesized as follows:

4-CH₃COOC₆H₄CH═CH₂ [CAS 2628-16-2; Available from Aldrich]

[symbol]

CF₃CF₂CF₂CF₂I

4-CH₃COOC₆H₄CHICH₂CF₂CF₂CF₂CF₃ [not in CA]

[symbol]

4-CH₃COOC₆H₄-CH₂CH₂CF₂CF₂CF₂CF₃ [not in CA]

[symbol]

4-HOC₆H₄-CH₂CH₂CF₂CF₂CF₂CF₃ [CA 171182-92-6]

(1 reference JP 07179384 CA 124:8394)

C₄F₉CH₂CH₂OTs+4-CH₃OC₆H₄MgBr→4-CH₃OC₆H₄CH₂CH₂CF₂CF₂CF₂CF₃

→4-HOC₆H₄-CH₂CH₂CF₂CF₂CF₂CF₃ route used

[symbol]

4-CH₂═CXCOOC₆H₄CH₂CH₂CF₂CF₂CF₂CF₃ [X═H, CH₃ not in CA]

The foregoing is illustrative of the present invention, and is not to be construed as limiting thereof. The invention is defined by the following claims, with equivalents of the claims to be included therein.

1. A polymer comprising:
(a) monomeric units containing a lipophobic group, said monomeric units comprising a compound of Formula I: 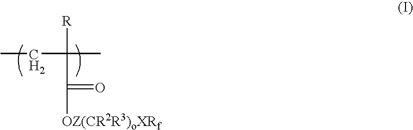
wherein:
Z is a spacer selected from the group consisting of —(CH₂)ₙ—, —Y—, —Y(CH₂)ₙ—, —(CH₂)ₙY—, and —(CH₂)ₙY(CH₂)_{n′}—, where Y is aryl;
R is H or methyl;
R_{f} is C3 to C6 fluoroalkyl optionally containing one or two heteroatoms selected from N and O;
R² and R³ are each independently H or halo;
X is —O— or a covalent bond;
o is 0 or 1 or 2;
n+n′ is 2 to 10; and
n+n′+o is not greater than 10.

2. The polymer of claim 1, wherein Z is aryl.

3. The polymer of claim 1, wherein Z is phenyl.

4. The polymer of claim 1, wherein said compound of Formula I is a compound of Formula Ia: 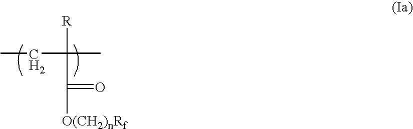
wherein:
R is H or methyl;
R_{f} is C3-C6 fluoroalkyl optionally containing one or two heteroatoms selected from N and O; and
n is 2 to 10.

5. The polymer of claim 1, wherein said compound of Formula I is a compound of Formula Ib: 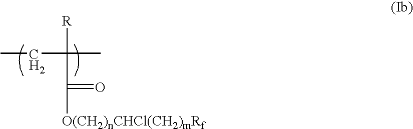
wherein:
R is H or methyl;
R_{f} is C3-C6 fluoroalkyl optionally containing one or two heteroatoms selected from N and O;
n is 1 to 9; and
m is 2 to 4.

6. The polymer of claim 1, wherein said compound of Formula I is a compound of Formula Ic: 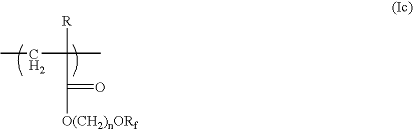
wherein:
R is H or methyl;
R_{f} is C₃-C₆ fluoroalkyl optionally containing a heteroatom selected from N and O; and
n is 5 to 10.

7. The polymer of claim 1, further comprising:
(b) monomeric units containing an attachment group.

8. The polymer of claim 7, further comprising;
(c) monomeric units containing a hydrophobic group.

9. The polymer of claim 8, wherein said hydrophobic group comprises an alkyl group.

10. The polymer of claim 7, wherein said attachment group comprises an epoxide, hydroxy, silane or amine group.

11. The polymer of claim 1, wherein said monomeric units containing a lipophobic group consists essentially of a compound of Formula I.

12. The polymer of claim 1, wherein n is 2 to 5 and m is 3.

13. The polymer of claim 1, wherein R is H.

14. The polymer of claim 1, wherein R is methyl.

15. The polymer of claim 1, wherein R_{f} is C3 to C5 linear or branched perfluoroalkyl.

16. A composition comprising a polymer in a carrier, said carrier selected from the group consisting of water, carbon dioxide, organic solvents, and combinations thereof;
said polymer comprising:
(a) monomeric units containing a lipophobic group, said monomeric units comprising a compound of Formula I: 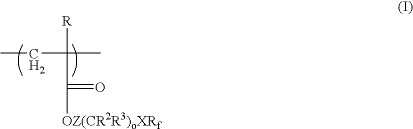
wherein:
Z is a spacer selected from the group consisting of —(CH₂)—, —Y—, —Y(CH₂)ₙ—, —(CH₂)ₙY—, and —(CH₂)ₙY(CH₂)ₙ′—, where Y is aryl;
R is H or methyl;
R_{f} is C3 to C6 fluoroalkyl optionally containing one or two heteroatoms selected from N and O;
R² and R³ are each independently H or halo;
X is —O— or a covalent bond;
o is 0 or 1 or 2;
n+n′ is 2 to 10; and
n+n′+o is not greater than 10.

17. A composition of claim 16, wherein said organic solvent is selected from the group consisting of alcohols, aromatic solvents, esters, ketones, aliphatic solvents, and combinations thereof.

18. A composition of claim 16, wherein said organic solvent is selected from the group consisting of acetone, hexane, cyclohexane, methanol, ethanol, ethyl acetate, toluene, acetone, methyl ethyl ketone, and mixtures thereof.

19. A composition of claim 17, wherein said composition is a solution, dispersion, suspension, emulsion or microemulsion.

20. A method of treating a substrate, comprising
(a) applying a polymer of claim 1 to said substrate so that said compound is deposited thereon.

21. The method of claim 20, wherein said applying step is carried out by spraying or dip coating.

22. The method of claim 20, wherein said applying step is followed by the step of:
(b) drying said substrate.

23. The method of claim 20, wherein said substrate is a textile material is selected from the group consisting of cotton, wool, silk, polyesters, polyamides and blends thereof.

24. The method of claim 20, wherein said substrate is a textile material selected from the group consisting of woven and nonwoven textile materials.

25. A textile material produced by the method of claim 22.

26. A textile material having a polymer of claim 11 deposited thereon or impregnated therein.

27. A paper product produced by the method of claim 20.

28. A paper product having a polymer of claim 1 deposited thereon or impregnated therein.

29. A carpet produced by the method of claim 20.

30. A carpet having a polymer of claim 1 deposited thereon or impregnated therein.

31. A wallpaper produced by the method of claim 20.

32. A wallpaper having a polymer of claim 1 deposited thereon or impregnated therein.

33. A method of making a polymer of claim 1, comprising polymerizing a monomer of Formula II: 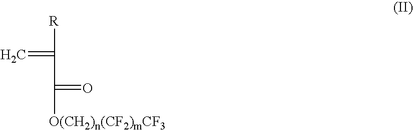
optionally in the presence of a comonomer, to produce said polymer of claim 1.

34. The method of claim 33, wherein said polymerizing step is carried out in carbon dioxide.
